(19) United States
(12) Patent Application Publication
(10) Pub. No.: US 2013/0309000 A1
(43) Pub. Date: Nov. 21, 2013

(54) HYBRID LASER ARC WELDING PROCESS AND APPARATUS

(71) Applicants: Dechao Lin, Greer, SC (US); David Vincent Bucci, Simpsonville, SC (US); Srikanth Chandrudu Kottilingam, Simpsonville, SC (US); Yan Cui, Greer, SC (US)

(72) Inventors: Dechao Lin, Greer, SC (US); David Vincent Bucci, Simpsonville, SC (US); Srikanth Chandrudu Kottilingam, Simpsonville, SC (US); Yan Cui, Greer, SC (US)

(73) Assignee: GENERAL ELECTRIC COMAPNY, Schenectady, NY (US)

(21) Appl. No.: 13/476,458

(22) Filed: May 21, 2012

(51) Int. Cl. B23K 28/02; B23K 101/00

(52) U.S. Cl. 403/270; 219/121.64; 219/121.63

(57) ABSTRACT

A welding method and apparatus that simultaneously utilize laser beams and arc welding techniques. The welding apparatus generates a first laser beam that is projected onto a joint region between at least two workpieces to produce a first laser beam projection on adjacent surfaces of the workpieces and to cause the first laser beam projection to travel along the joint region and penetrate the joint region. The apparatus also generates an electric arc to produce an arc projection that encompasses the first laser beam projection and travels therewith along the joint region to form a molten weld pool. In addition, the apparatus generates a pair of lateral laser beams that produce lateral laser beams projections that are encompassed by the arc projection and are spaced laterally apart from the joint region to interact with portions of the weld pool that solidify to define weld toes of the weld joint.

### BACKGROUND OF THE INVENTION

The present invention generally relates to welding methods. More particularly, this invention is directed to a welding process that utilizes a hybrid laser arc welding technique in which laser beam welding and arc welding simultaneously occur in the same weld pool wherein at least one lateral laser beam is capable of promoting a smooth transition at the weld bead toes along the lateral edges of the resulting weld joint.

Low-heat input welding processes, and particularly high-energy beam welding processes such as laser beam and electron beam welding (LBW and EBW, respectively) operated over a narrow range of welding conditions, have been successfully used to produce crack-free weld joints in a wide variety of materials, including but not limited to alloys used in turbomachinery. An advantage of high-energy beam welding processes is that the high energy density of the focused laser or electron beam is able to produce deep narrow weld beads of minimal weld metal volume, enabling the formation of structural butt weld joints that add little additional weight and cause less component distortion in comparison to other welding techniques, such as arc welding processes. Additional advantages particularly associated with laser beam welding include the ability to be performed without a vacuum chamber or radiation shield usually required for electron beam welding. Consequently, laser beam welding can be a lower cost and more productive welding process as compared to electron beam welding.

Though filler materials have been used for certain applications and welding conditions, laser beam and electron beam welding processes are typically performed autogenously (no additional filler metal added). The high-energy beam is focused on the surface to be welded, for example, an interface (weld seam) between two components to be welded. During welding, the surface is sufficiently heated to vaporize a portion of the metal, creating a cavity (“keyhole”) that is subsequently filled by the molten material surrounding the cavity. A relatively recent breakthrough advancement in laser beam welding is the development of high-powered solid-state lasers, which as defined herein include power levels of greater than four kilowatts and especially eight kilowatts or more. Particular examples are solid-state lasers that use ytterbium oxide (Yb₂O₃) in disc form (Yb:YAG disc lasers) or as an internal coating in a fiber (Yb fiber lasers). These lasers are known to be capable of greatly increased efficiencies and power levels, for example, from approximately four kilowatts to over twenty kilowatts.

Hybrid laser arc welding (HLAW), also known as laser-hybrid welding, is a process that combines laser beam and arc welding techniques, such that both welding processes simultaneously occur in the same molten weld pool. An example of an HLAW process is schematically represented in FIGS. 1 and 2 as being performed to produce a butt weld joint 10 between faying surfaces 12 and 14 of two workpieces 16 and 18. As evident from FIG. 1, a laser beam 20 is oriented perpendicular to adjacent surfaces 24 of the workpieces 16 and 18, while an electric arc 22 and filler metal (not shown) of the arc welding process are positioned behind (aft) and angled forward toward the focal point 26 of the laser beam 20 on the workpiece surfaces 24. The arc welding process may be, for example, gas metal arc welding (GMAW, also known as metal inert gas (MIG) welding) or gas tungsten arc welding (GTAW, also known as tungsten inert gas (TIG) welding, and generates what will be referred to herein as an arc projection 28 that is projected onto the workpiece surfaces 24. The aft position of the arc welding process is also referred to as a “forehand” welding technique, and the resulting arc projection 28 is shown as encompassing the focal point 26 of the laser beam 20. The resulting molten weld pool (not shown) produced by the laser beam 20 and electric arc 22 generally lies within the arc projection 28 or is slightly larger than the arc projection 28.

Benefits of the HLAW process include the ability to increase the depth of weld penetration and/or increase productivity by increasing the welding process travel speed, for example, by as much as four times faster than conventional arc welding processes. These benefits can be obtained when welding a variety of materials, including nickel-based, iron-based alloys, cobalt-based, copper-based, aluminum-based, and titanium-based alloys used in the fabrication of various components and structures, including the construction of wind turbine towers used in power generation applications, as well as components and structures intended for a wide variety of other applications, including aerospace, infrastructure, medical, industrial applications, etc.

Even though laser beam welding is known to have benefits as noted above, limitations may occur when welding certain materials. As a nonlimiting example, molten weld pools formed in nickel-based superalloys tend to exhibit lower fluidity and reduced wetting than other metallic materials, such as mild steels, stainless steels and low-alloy steels. This “sluggishness” can lead to defects in the resulting weld joint, for example, overlapping defects in the region of the weld bead referred to herein as the weld bead toes or simply weld toes. FIGS. 3 and 4 are images showing a weld bead produced by an HLAW process and having an overlapping weld defect characterized by irregular lateral edges. As evident from FIGS. 3 and 4, the irregular edges of the weld bead are defined by the weld toes, which overlap the adjacent base material of the components welded together by the weld bead to define transition regions between the weld bead and the base material.

Reducing or eliminating irregular weld toes in weld joints produced by HLAW processes would be particularly advantageous from the standpoint of achieving longer lives for components subjected to cyclic operations. One commercial example is the fabrication of wind turbine towers, whose fabrication requires butt weld joints to join very long and thick sections of the towers.

### BRIEF DESCRIPTION OF THE INVENTION

The present invention provides a welding method and apparatus that utilize an HLAW (hybrid laser arc welding) technique, in which laser beam welding and arc welding are simultaneously utilized to produce a molten weld pool. The welding method and apparatus are capable of promoting a smooth transition at weld toes that define the lateral edges of the resulting weld joint, and are particularly well suited for welding relatively thick sections formed of materials whose weld pools exhibit relatively low fluidity and wetting.

According to one aspect of the invention, the welding method involves placing at least two workpieces together so that faying surfaces thereof face each other and a joint region is defined therebetween. A first laser beam is then projected onto the joint region to produce a first laser beam projection on adjacent surfaces of the workpieces and cause the first laser beam projection to travel along the joint region and penetrate the joint region. In addition, an electric arc is directed onto the adjacent surfaces of the workpieces to produce an arc projection that encompasses the first laser beam projection and travels therewith along the joint region. The first laser beam projection and the arc projection form a molten weld pool capable of solidifying to form a weld joint in the joint region. A pair of lateral laser beams produce lateral laser beam projections that are encompassed by the arc projection and travel therewith along the joint region behind the first laser beam projection. The lateral laser beam projections interact with and affecting portions of the molten weld pool that define lateral edges of the molten weld pool. The molten weld pool is then cooled to form the weld joint in the joint region and metallurgically join the workpieces to yield a welded assembly. According to a preferred aspect of the invention, the weld joint has uniform lateral edges and smooth weld toes that define the uniform lateral edges.

According to another aspect of the invention, the welding apparatus includes means for projecting a first laser beam onto a joint region between at least two workpieces to produce a first laser beam projection on adjacent surfaces of the workpieces and to cause the first laser beam projection to travel along the joint region and penetrate the joint region. The apparatus also includes means for directing an electric arc onto the adjacent surfaces of the workpieces to produce an arc projection that encompasses the first laser beam projection and travels therewith along the joint region to form a molten weld pool capable of solidifying to form a weld joint in the joint region. In addition, the apparatus includes means for projecting a pair of lateral laser beams to produce lateral laser beam projections that are encompassed by the arc projection, travel therewith along the joint region and behind the first laser beam projection, and are spaced laterally apart from the joint region.

According to a preferred aspect of the invention, the hybrid laser arc welding process utilizes the lateral laser beams to control the weld bead formation, and in particular to eliminate or at least reduce the incidence of defects in the weld toes of a weld bead. The electric arc and first laser beam are primarily responsible for generating the molten weld pool, while the lateral laser beams are focused near the lateral edges of the weld pool. Furthermore, the lateral laser beams are sufficiently close to the weld arc and of sufficient power so that the weld pool and its resulting weld bead are affected by the lateral laser beams to produce a weld joint whose weld toes are preferably smooth and whose lateral edges are preferably uniform.

Other aspects and advantages of this invention will be better appreciated from the following detailed description.

### BRIEF DESCRIPTION OF THE DRAWINGS

FIGS. 1 and 2 are schematic representations showing side and plan views, respectively, of two workpieces abutted together and undergoing a hybrid laser arc welding process in accordance with the prior art.

FIGS. 3 and 4 are images showing plan and cross-sectional views, respectively, of a weld joint produced by a hybrid laser arc welding process of the type represented in FIGS. 1 and 2.

FIGS. 5 and 6 are schematic representations showing side and plan views, respectively, of two workpieces abutted together and undergoing a hybrid laser arc welding process in accordance with an embodiment of the present invention.

FIG. 7 is a schematic representation of a laser welding apparatus suitable for use in the hybrid laser arc welding process represented in FIGS. 5 and 6.

FIGS. 8 through 11 are images showing cross-sectional views of weld joints produced by experimental hybrid laser arc welding processes.

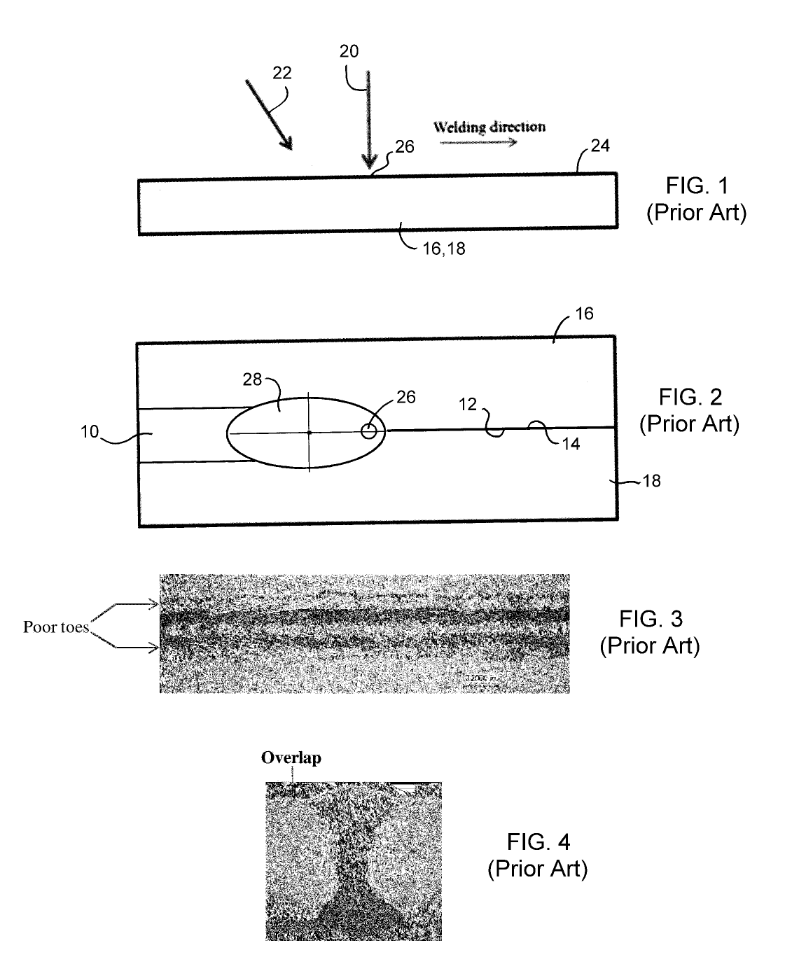

### DETAILED DESCRIPTION OF THE INVENTION

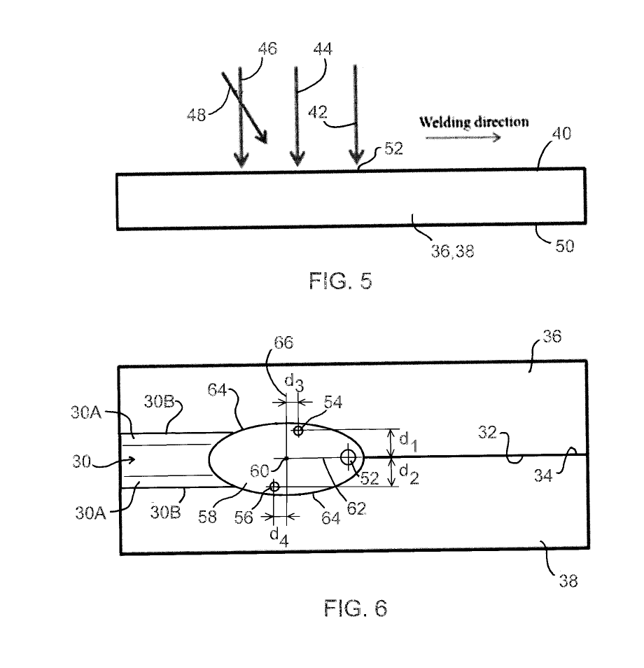

FIGS. 5 and 6 represent a welding process that utilizes multiple laser beams in a hybrid laser arc welding (HLAW) process in accordance with an embodiment of the present invention. In particular, the process combines laser beam and arc welding techniques, such that both welding processes simultaneously occur in the same molten weld pool. As schematically represented in FIGS. 5 and 6, the welding process can be performed to produce a butt weld joint 30 between faying surfaces 32 and 34 of two workpieces 36 and 38 to form a welded assembly, though it should be understood that the process is not limited to butt weld joints and any number of workpieces can be welded together. Each faying surface 32 and 34 is contiguous with an adjacent surface 40 of one of the workpieces 36 and 38. With a corresponding surface 50 on the opposite side of each workpiece 36 and 38, the workpiece surfaces 40 define the through-thicknesses of the workpieces 36 and 38.

The invention may use various arc welding processes, for example, gas shielded arc welding, including gas tungsten arc welding (GTAW, or tungsten inert gas (TIG)), which uses a nonconsumable tungsten electrode, and gas metal arc welding (GMAW, or metal inert gas (MIG)), which uses a consumable electrode formed of the weld alloy to be deposited. These welding techniques involve the application of a sufficient electric potential between the electrode and substrate to be welded to generate an electric arc therebetween. Because the electrodes of GTAW techniques are not consumed, a wire of a suitable filler alloy must be fed into the arc, where it is melted and forms metallic drops that deposit onto the substrate surface. In contrast, the consumable electrode of a GMAW technique serves as the source of filler material for the overlay weld. Various materials can be used as a filler material, with preferred materials depending on the compositions of the workpieces 36 and 38 and the intended application. For example, a ductile filler may be preferred to reduce the tendency for cracking in the weld joint 30, or a filler may be used whose chemistry closely matches the base metal (or metals) of the workpieces 36 and 38 to more nearly maintain the desired properties of the workpieces 36 and 38.

The laser welding process employed in FIGS. 5 and 6 preferably utilizes a least one high-powered laser as the source of any one or more of the laser beams 42, 44 and 46. Preferred high-powered lasers are believed to include solid-state lasers that use ytterbium oxide (Yb₂O₃) in disc form (Yb:YAG disc lasers) or as an internal coating in a fiber (Yb fiber lasers). Typical parameters for the high-powered laser welding process include a power level of up to four kilowatts, for example, up to eight kilowatts and possibly more, and laser beam diameters in a range of about 300 to about 600 micrometers. Other suitable operating parameters, such as pulsed or continuous mode of operation and travel speeds, can be ascertained without undue experimentation. Control of the laser(s) can be achieved with any suitable robotic machinery or CNC gantry system. Consistent with laser beam welding processes and equipment known in the art, the laser beams 42, 44 and 46 do not require a vacuum or inert atmosphere, though the process preferably uses a shielding gas, for example, an inert shielding gas, active shielding gas, or a combination thereof to form a mixed shielding gas.

Though not represented in FIGS. 5 and 6, it is within the scope of the invention to provide a shim between the faying surfaces 32 and 34 of the workpieces 36 and 38. The shim can be utilized to provide fill metal for the weld joint 30, and/or provide additional benefits as described in U.S. Published Patent Application No. 2010/0243621, for example, stabilizing the weld keyhole to reduce spattering and discontinuities during high-powered laser beam welding.

As depicted in FIG. 5, the three laser beams 42, 44 and 46 are preferably projected in a direction normal to the workpiece surfaces 40, although it is foreseeable that the laser beams 42, 44 and 46 may be projected at an angle of about 70 to about 110 degrees to the adjacent workpiece surfaces 40 of the workpieces 36 and 38. For example, laser beams 42, 44 and 46 may be tilted relative to the workpiece surfaces 40 to be used in some applications to mitigate laser beam reflection and reduce spattering from a molten pool (not shown) so as to increase laser head life. An electric arc 48 and filler metal (not shown) of the arc welding process are positioned behind (aft) and angled forward toward a focal point of the laser beam 42 that generates a beam projection 52 on the workpiece surfaces 40. The arc welding process generates an arc projection 58 on the workpiece surfaces 40 that encompasses the beam projection 52 of the laser beam 42, as well as the beam projections 54 and 56 of the laser beams 44 and 46. The resulting molten weld pool produced by the laser beams 42, 44 and 46 and the electric arc 48 generally lie within the arc projection 58 or is slightly larger than the arc projection 58.

On the basis of FIGS. 5 and 6, the hybrid laser arc welding process comprises multiple welding steps that are performed in sequence, with a first of the processes being performed by the laser beam 42 to preferably yield a relatively deep-penetrating weld. The laser beam projection 52 and the center 60 of the arc projection 58 are represented as being projected onto a line 62 that coincides with a joint region defined by and between the faying surfaces 32 or 34 (or any gap therebetween), whereas the projections 54 and 56 of the lateral laser are spaced laterally apart from the joint region (faying surfaces 32 and 34). In combination, the laser beam 42 and the electric arc 48 are intended to generate the primary welding effect, meaning that the molten weld pool and the resulting deep-penetrating weld joint 30 that metallurgically joins the workpieces 36 and 38 is predominantly if not entirely produced by the combined effect of the laser beam 42 and the electric arc 48. To create the desired molten weld pool, a center point of the projection 52 of laser beam 42 and the center 60 of the arc projection 58 of the electric are 48 should be between about 2 to about 20 millimeters apart along the joint to be welded, more preferably about 5 to about 15 millimeters. To mitigate laser power loss and not to disturb metal transfer in the arc, the laser beam 42 has to keep a minimum spacing to the arc. In addition, too large of spacing, for example more than 20 millimeters, may lose the synergy of the laser beam 42 and the electric arc 48. To penetrate thick sections, for example, one centimeter or more, the laser beam 42 is preferably generated with a power level of about 2 kW or more, preferably about 4 kW or more, and more preferably about 8 or more. A suitable upper limit is believed to be about 20 kW for workpiece surfaces 40 having a thickness of more than one centimeter. A more stable keyhole (a resulting hole that is formed when the sides of the workpiece surfaces 40 melt away on each side of the weld pool) can be achieved by increasing power in laser beam 42, therefore a thicker material can be fully penetrated in a single pass with laser hybrid welding. In contrast, the laser beams 44 and 46 do not intentionally penetrate the through-thicknesses of the workpieces 36 and 38, and instead are intended to interact with the molten weld pool formed by the leading laser beam 42 and electric arc 48. For this reason, the laser beams 44 and 46 can be operated at power levels less than that of the laser beam 42. The projections 52, 54, 56 and 58 of the laser beams 42, 44 and 46 and electric arc 48 are all caused to simultaneously travel, preferably in unison, in a welding direction as indicated in FIG. 5.

Welding processes of the type represented in FIGS. 5 and 6 are particularly well suited for fabricating components that require welding relative thick sections, for example, one centimeter or more, as is the case for fabricating various components used in power generation applications, including the construction of wind turbine towers, as well as components intended for a wide variety of other applications, including aerospace, infrastructure, medical, industrial applications, etc. The workpieces 36 and 38 may be castings, wrought, or powder metallurgical form, and may be formed of a variety of materials, nonlimiting examples of which include nickel-based, iron-based alloys, cobalt-based, copper-based, aluminum-based, and titanium-based alloys. However, certain advantages associated with this invention are particularly beneficial when welding workpieces formed of materials that exhibit lower fluidity and reduced wetting than mild, stainless and low-alloy steels, notable examples of which include nickel-based superalloys. In particular, the additional laser beams 44 and 46 are preferably utilized so that their respective projections 54 and 56 are projected near or onto the lateral edges 64 of the molten weld pool created and temporarily sustained by the leading laser beam 42 and electric arc 48, and prior to solidification of the molten weld that results in the weld joint 30. More particularly, the laser beam projections 54 and 56 serve to mix and churn the molten weld material that defines the lateral edges 64 of the molten weld pool for the purpose of having a smoothing effect within the weld toes 30A that define the outermost lateral edges 30B of the weld 30 joint. Such an effect is intended to promote longer a life for the weld joint 30 if subjected to cyclic operations. It should be noted that the desired effect of the additional laser projections 54 and 56 could be attained in the presence of still more laser beams projected on the molten weld pool, and therefore the invention is intended to utilize but is not limited to the use of the three laser beams 42, 44 and 46 represented in FIGS. 5 and 6.

To achieve the above-noted smoothing effect on the lateral edges 30B of the weld joint 30, the power levels of the laser beams 42, 44 and 46 and the diameters and placements of their projections 52, 54 and 56 are preferably controlled. As previously noted, in order to penetrate the through-thickness of the workpieces 36 and 38, the leading laser beam 42 is preferably generated at a higher power level than the additional laser beams 44 and 46. To achieve a similar smoothing effect within each weld toe 30A and along each lateral edge 30B of the weld joint 30, the additional laser beams 44 and 46 are preferably generated at the same power level and the diameters of their projections 54 and 56 are preferably the same or are within at least 50 percent of each other. On the other hand, the leading laser beam 42 will typically be at a power level of at least 200 percent higher, and more preferably about 400 to 1000 percent higher, than either laser beam 44 and 46, which is intended to ensure than the laser beams 44 and 46 do not penetrate the workpieces 36 and 38. However, it should be understood that optimal power levels for the laser beams 42, 44 and 46, as well as optimal diameters for their respective projections 52, 54 and 56, will depend on the particular materials being welded and other factors capable of affecting the welding process.

The placements of the beam projections 54 and 56 are preferably controlled relative to the projection 58 of the electric arc 48. The lateral offset distances between the laser beam projections 54 and 56 and the leading laser beam projection 52 (perpendicular to the welding direction) are indicated by “d₁” and “d₂” in FIG. 6, and the longitudinal offset distances between the laser beam projections 54 and 56 and the center 60 of the projection 58 (parallel to the welding direction) are indicated by “d₃” and “d₄” in FIG. 6. While the distances d₁ and d₂ associated with both projections 54 and 56 are represented as being identical, it is foreseeable that either or both of these distances could differ among the projections 54 and 56. Furthermore, while the projections 54 and 56 are represented as being forward and aft, respectively, of a lateral line 66 through the center 60 of the arc projection 58, it is foreseeable that the either or both of the projections 54 and 56 could be forward or aft of the lateral line 66 or directly on the lateral line 66. The offset distances of projections 54 and 56 indicated by d₁, d₂, d₃ and d₄ may each be of any distance that enables the projections 54 and 56 to interact with the lateral edges 64 of the weld pool. In practice, particularly suitable offset distances d₁, d₂, d₃ and d₄ have been found to be distances that place the location of the projections 54 and 56 within 10 millimeters of the center 60 of the projection 58.

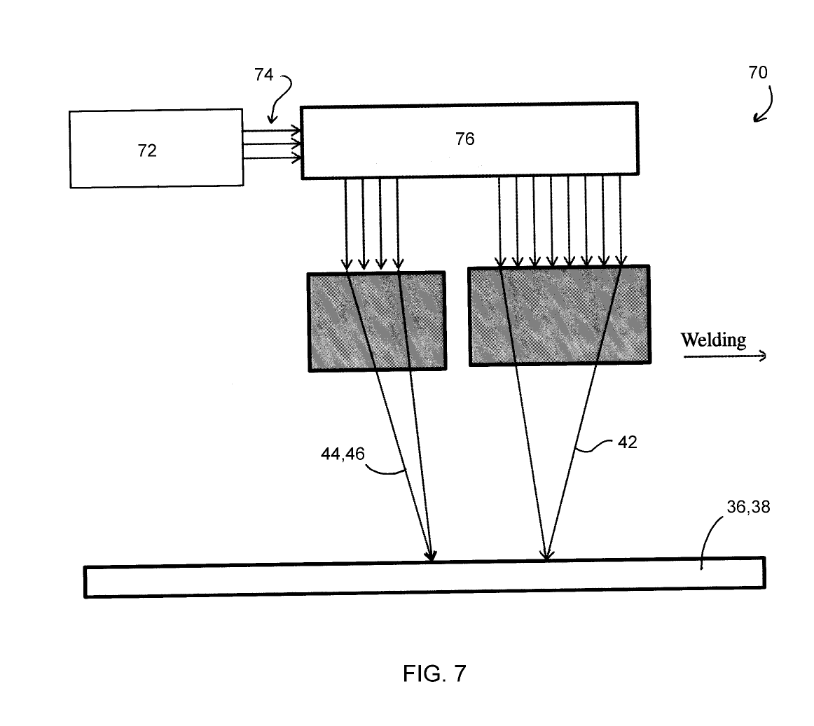

The power levels of the laser beams 42, 44 and 46 and the diameters and distances (d₁, d₂, d₃ and d₄) between their projections 52, 54 and 56 can be controlled and adjusted by generating each laser beam 42, 44 and 46 with a separate laser beam generator or by splitting one or more laser beams. Generating the separate laser beams 42, 44 and 46 by splitting a primary laser beam is preferred in view of the difficulty of closely placing three separate laser beam generators to produce the three parallel beams 42, 44 and 46. Accordingly, FIG. 7 represents an apparatus 70 that utilizes a single high-powered laser 72 for generating a primary laser beam 74, which is then split by a suitable beam splitter 76 (for example, a prism) to create the leading and lateral laser beams 42, 44 and 46. The splitter 76 can also serve to align and space the beams 42, 44 and 46 along and relative to the joint region defined by the faying surfaces 32 and 34, and to orient the beams 42, 44 and 46 to be parallel to each other and perpendicular to the surfaces 40 of the workpieces 36 and 38. Because the leading laser beam 42 is intended to be at a higher power level in order to deeply penetrate the workpieces 36 and 38, a greater proportion of the primary laser beam 74 is represented as being utilized to produce the leading laser beam 42 and a smaller proportion of the primary laser beam 74 is represented as being utilized to produce the lateral laser beams 44 and 46. As a nonlimiting example, if a 4 kW laser generator 72 is employed, the splitter 76 could be used to produce the leading laser beam 42 at a power level of about 2 kW and each of the two lateral beams 44 and 46 at a power level of about 1 kW. As another example, if a 8 kW laser generator 72 were to be employed, the splitter 76 could be used to produce the leading laser beam 42 at a power level of about 6 kW and each of the two lateral beams 44 and 46 at a power level of about 1 kW.

Optimal spacing among the laser beam projections 52, 54 and 56 will depend on their relative power levels and the particular application. However, experiments leading up to the present invention evidenced the importance of the power levels of the lateral laser beams 44 and 46 and the placement of their projections 54 and 56 in proximity to the lateral edges 64 of the molten weld pool within the arc projection 58. For this purpose, a series of trials were performed in which a MIG welder and a single lateral beam were operated to produce weld beads on specimens formed of stainless steel 304L. The welding speed for all trials was 60 inches (about 150 cm) per minute. A single lateral beam (corresponding to one of the beams 44 and 46) was utilized in the trials in order to provide a contrast between the weld toes and lateral edges at the opposite sides of the resulting weld beads. The MIG welder was operated at conditions that included a voltage of about 25V and a welding current of about 160 A, which resulted in an arc power of about 4 kW. Electrodes used in the welding process were formed of stainless steel filler metal ER308L. The lateral laser beam projection (corresponding to 54 or 56 in FIG. 6) had a diameter less than 2 millimeters. The projection of the lateral beam was maintained a distance of about five millimeters forward of the center (corresponding to 60 in FIG. 6) of the molten weld pool within the arc projection (corresponding to 58 in FIG. 6), and both its power level and lateral distance (corresponding to d₁ in FIG. 6) from the center of the molten weld pool (arc projection) were used as variables in the trials.

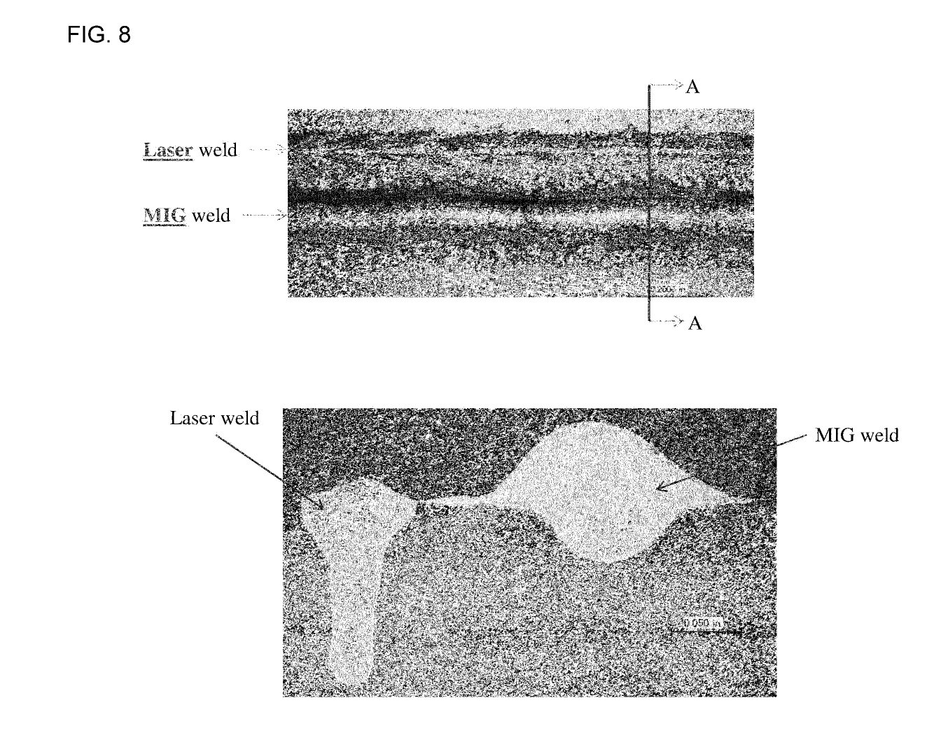

FIG. 8 represents the results of a first trial in which the lateral laser beam was at a power level of about 2 kW and its projection was located about 4.5 millimeter from the center of the MIG molten weld pool. FIG. 8 evidences that interaction did not occur between the weld bead produced by the electric arc and a deeper weld bead produced by the lateral laser beam, and the resulting weld toes and lateral edges of the weld bead formed by the electric arc were rough and irregular, respectively. Consequently, it was concluded that the lateral beam projection was not sufficiently close to the MIG molten weld pool to have any influence on the resulting weld bead.

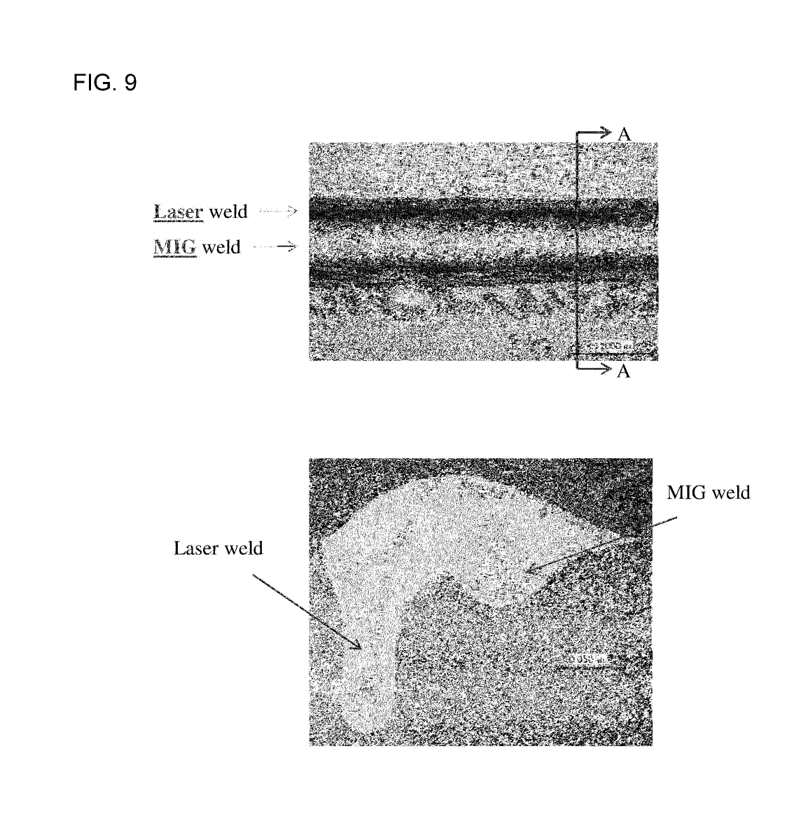

FIG. 9 represents the results of a second trial in which the lateral beam was again at a power level of about 2 kW, but its projection was located about 2.5 millimeter from the center of the MIG molten weld pool. FIG. 9 evidences that significant interaction occurred between the weld beads produced by the lateral laser beam and the electric arc, resulting in a region of the weld bead being formed by the combined effects of the laser beam and electric arc. In this trial, the resulting weld toe and lateral edge of the weld bead adjacent the lateral laser beam projection were smooth and uniform, respectively, especially relative to the opposite weld toe and lateral edge of the weld bead. Consequently, it was concluded that the lateral beam projection was sufficiently close to the molten weld pool to have a beneficial effect on the resulting weld bead.

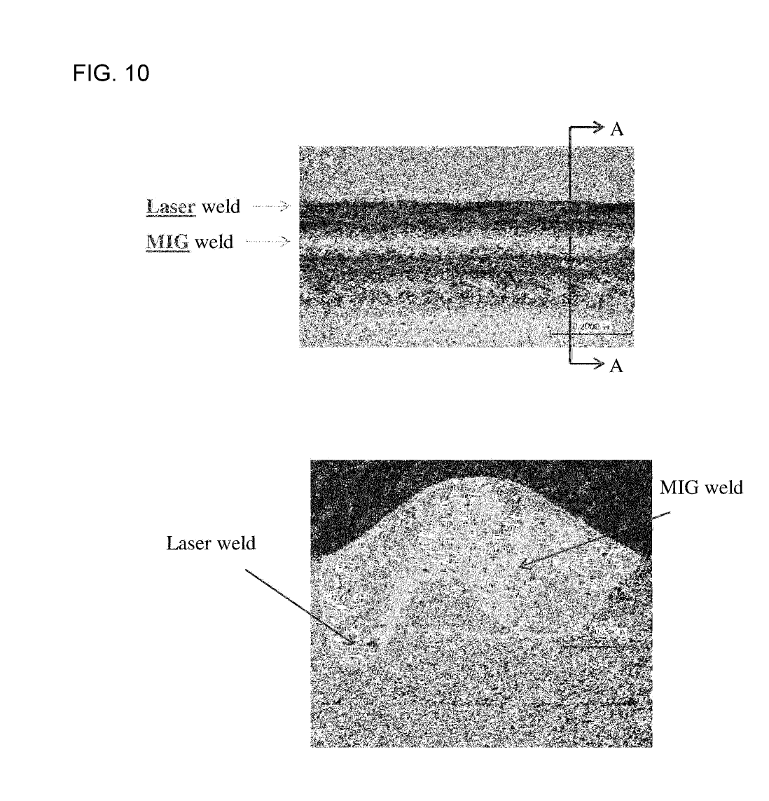

In a third trial represented in FIG. 10, the lateral beam projection was again located about 2.5 millimeter from the center of the MIG molten weld pool, but its power level was reduced to about 1 kW. FIG. 10 evidences that significant interaction still occurred between the weld beads produced by the lateral laser beam and the electric arc, and the resulting weld toe and lateral edge of the weld bead adjacent the lateral laser beam projection were smooth and uniform, respectively, especially relative to the opposite weld toe and lateral edge of the weld bead. Consequently, it was again concluded that the lateral beam projection was sufficiently close to the molten weld pool and at a sufficient power level to have a beneficial effect on the resulting weld bead.

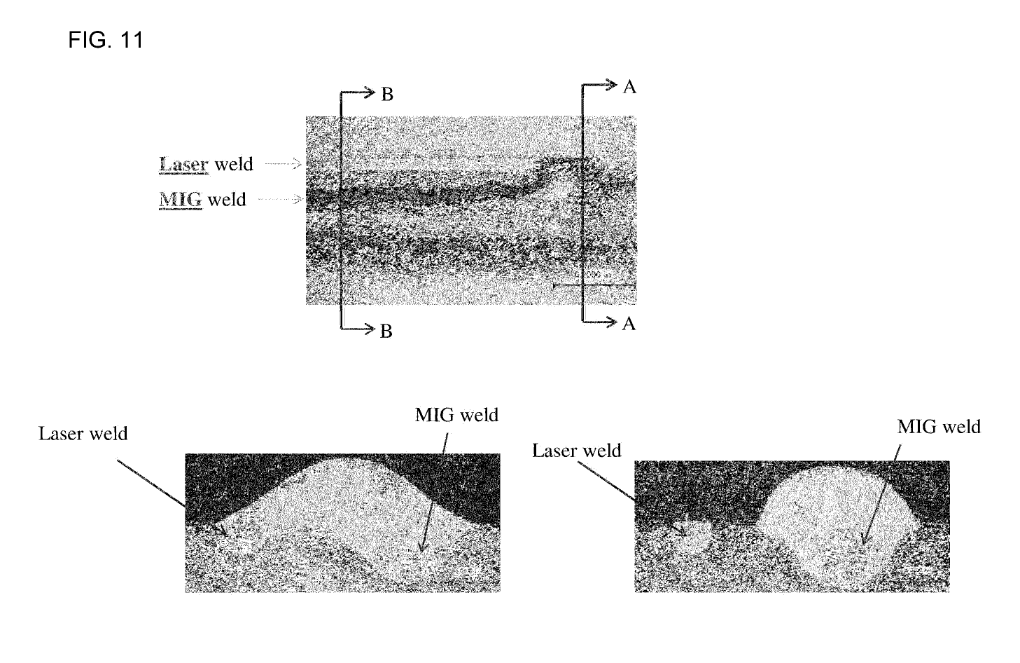

In a fourth trial represented in FIG. 11, the lateral beam projections were located about 2.5 millimeter from the center of the MIG molten weld pool, but their power levels were reduced to about 0.5 kW. FIG. 11 evidences that interaction did not occur between the weld beads produced by the lateral laser beam and the electric arc, and the resulting weld toes and lateral edges of the resulting weld bead were rough and irregular, respectively. Consequently, it was concluded that the lateral beam projection was not sufficiently close to the molten weld pool and/or its power level was too low to have any significant and beneficial influence on the resulting weld bead.

Under the particular test conditions used, it was concluded that the lateral laser beam (44/46) should be relatively closely spaced to the lateral edge of the arc projection, for example, within 2.5 millimeters of the lateral edge, and should be at a power level of about 1 kW or higher, to produce a weld joint whose weld toes are smooth and whose lateral edges are uniform.

While the invention has been described in terms of a preferred embodiment, it is apparent that other forms could be adopted by one skilled in the art. Accordingly, the scope of the invention is to be limited only by the following claims.

1. A method of welding at least two workpieces together by metallurgically joining faying surfaces of the workpieces, the method comprising:
placing the workpieces together so that the faying surfaces thereof face each other and a joint region is defined therebetween;
projecting a first laser beam onto the joint region to produce a first laser beam projection on adjacent surfaces of the workpieces and cause the first laser beam projection to travel along the joint region and penetrate the joint region;
directing an electric arc onto the adjacent surfaces of the workpieces to produce an arc projection that encompasses the first laser beam projection and travels therewith along the joint region, the first laser beam projection and the arc projection forming a molten weld pool capable of solidifying to form a weld joint in the joint region;
projecting a pair of lateral laser beams to produce lateral laser beams projections that are encompassed by the arc projection and travel therewith along the joint region behind the first laser beam projection, the lateral laser beams projections interacting with and affecting portions of the molten weld pool that define lateral edges of the molten weld pool; and then
cooling the molten weld pool to form the weld joint in the joint region and metallurgically join the workpieces to yield a welded assembly, the weld joint having uniform lateral weld bead edges and weld bead toes that define the uniform lateral edges.

2. The method according to claim 1, wherein the first laser beam is at a power level greater than each of the lateral laser beams.

3. The method according to claim 1, wherein the first laser beam is at a power level of about 2 kW to about 20 kW.

4. The method according to claim 1, wherein the lateral laser beams are at different power levels.

5. The method according to claim 1, wherein the first laser beam penetrates a through-thickness of the workpieces at the joint region and the lateral laser beams do not penetrate the through-thickness of the workpieces at the joint region.

6. The method according to claim 1, wherein a center of the arc projection and a center of the first laser beam are located about 2 millimeters to about 20 millimeters apart along the joint to be welded.

7. The method according to claim 1, wherein each of the lateral laser beams is spaced from a center of the arc projection by a distance of less than 10 millimeters.

8. The method according to claim 1, wherein the first laser beam and the lateral laser beams are parallel to each other along the welding joint.

9. The method according to claim 8, wherein the first laser beam and the lateral laser beams are projected at an angle of about 70 to about 110 degrees to the adjacent surfaces of the workpieces.

10. The method according to claim 1, wherein the molten weld pool is a molten material that exhibits lower fluidity and reduced wetting in comparison to molten mild, stainless and low-alloy steels.

11. The method according to claim 10, wherein the molten material is a nickel-based alloy.

12. The method according to claim 1, wherein the welded assembly is a power generation, aerospace, infrastructure, medical, or industrial component.

13. The method according to claim 1, wherein the welded assembly is a component of a wind turbine tower.

14. An apparatus for welding at least two workpieces together by metallurgically joining faying surfaces thereof that face each other to define a joint region therebetween, the apparatus comprising:
means for projecting a first laser beam onto the joint region to produce a first laser beam projection on adjacent surfaces of the workpieces and cause the first laser beam projection to travel along the joint region and penetrate the joint region;
means for directing an electric arc onto the adjacent surfaces of the workpieces to produce an arc projection that encompasses the first laser beam projection and travels therewith along the joint region to form a molten weld pool capable of solidifying to form a weld joint in the joint region;
means for projecting a pair of lateral laser beams to produce lateral laser beams projections that are encompassed by the arc projection and travel therewith along the joint region and behind the first laser beam projection, the means for projecting the lateral laser beams spacing the lateral laser beams projections laterally apart from the joint region.

15. The apparatus according to claim 14, wherein the means for projecting the first laser beam and the means for projecting the lateral laser beams operate to produce the first laser beam at a power level greater than each of the lateral laser beams.

16. The apparatus according to claim 14, wherein each of the lateral laser beams is spaced from a center of the arc projection by a distance of less than 10 millimeters.

17. The apparatus according to claim 14, wherein the first laser beam and the lateral laser beams are parallel to each other along the welding joint.

18. The apparatus according to claim 14, wherein the first laser beam and the lateral laser beams are projected at an angle of about 70 to about 110 degrees to the adjacent surfaces of the workpieces.

19. A weld joint metallurgically joining faying surfaces of at least two workpieces together so that the faying surfaces thereof face each other and a joint region is defined therebetween, the weld joint having uniform lateral weld bead edges and weld bead toes that define uniform lateral edges, the weld joint comprising:
a first region on adjacent surfaces of the workpieces, the first region being formed by projecting a first laser beam onto the joint region and the adjacent surfaces to produce a first laser beam projection on the adjacent surfaces and also directing an electric arc onto the adjacent surfaces to produce an arc projection that encompasses the first laser beam projection; and
a second region contiguous with a first edge of the first region and formed by projecting a lateral laser beam onto the adjacent surface of a first of the workpieces to produce a lateral laser beam projection that is encompassed by the arc projection, the lateral laser beam projection interacting with and affecting the first edge of the first region of the weld joint.

20. The weld joint according to claim 19, further comprising a third region contiguous with a second edge of the first region opposite the first edge of the weld joint, the third region being formed by projecting a second lateral laser beam onto the adjacent surface of a second of the workpieces to produce a second lateral laser beam projection that is encompassed by the arc projection, the second lateral laser beam projection interacting with and affecting the second edge of the first region of the weld joint.
